(19) United States
(12) Patent Application Publication
(10) Pub. No.: US 2001/0033730 A1
(43) Pub. Date: Oct. 25, 2001

(54) Adapter retaining method and pull-protector for fiber optic cable

(76) Inventor: Vernon Fentress, Herndon, VA (US)

Correspondence Address: HANDAL & MOROFSKY, 80 WASHINGTON STREET, NORWALK, CT, 06854, US

(21) Appl. No.: 09/788,937

(22) Filed: Feb. 20, 2001

Related U.S. Application Data
(60) Provisional application No. 60/183,196, filed on Feb. 17, 2000.

(51) Int. Cl. G02B 6/36

(52) U.S. Cl. 385/139; 385/100

(57) ABSTRACT

A fiber optic cable connector device capable of coupling fiber optic cables for use in installing a fiber optic cable network including a cap member having an for receiving and securing a fiber optic cable end portion, a sleeve member having a retaining device to receive, engage and secure the cap member containing a fiber optic cable end portion, and a coupling member having a retaining device to receive, engage and secure the assembled fiber optic cable end portion, sleeve and cap members. An adapter, having fiber conduit slidably mounted within a support member housing, provides an interface for coupling multiple single-fiber carrying fiber optic cables and dual fiber carrying fiber optic cables. A method of terminating fiber optic ends with little or no polishing incorporates viewing the illuminated fiber end-face through a microscope.

### BACKGROUND OF THE INVENTION

1. Field of the Invention

The present invention relates to a new and improved method and apparatus for installing fiber optic cables. More particularly, the invention relates to an inventive method of aligning fibers and fiber end-faces to eliminate the need for polishing, and inventive improvements in fiber optic cable components, such as adapters, connectors, coupling assemblies and pull protectors, to provide high quality termination of fiber optic cables and ease of cable installation in the field.

2. Description of Related Art Including Information Disclosed under 37 CFR 1.97 and 37 CFR 1.98

Typically, fiber optic cables installed in or between buildings to enable intra-organizational data and telephone communications are housed in conduits and connected with de-matable connectors. The benefits of fiber optics for use in these local networks are many. However, the primary benefit lies in the ability to send the information of many telecommunication instruments over an exceedingly small number of channels as compared to conventional copper cables. A single pair of optical fibers may, in fact, replace several hundred pairs of copper cables.

Fiber optic cables are desirable because of a need for high capacity small cables, especially where conventional copper or coaxial cables of equivalent capacity will not fit, e.g., in small or congested cable ducts. Copper or coaxial cable bundles as large as 100 mm in diameter can be avoided in favor of fiber optic cables as small as 3 mm in diameter.

However, single channel de-matable fiber optic connectors which are used to terminate the cable are typically 8 to 20 millimeters in diameter. This results in a connector bundles having diameters much larger then the cable diameters. For example, a typical AT&T Technologies connector used to terminate a typical 6 channel, 8 mm diameter, fiber optic cable will result in a bundle size of 36.7 mm, which is over four (4) times the size of the cable. The National Electrical Code limits a single cable to 53% of the conduit area. Thus, the 8-mm cable can easily fit a standard ½-inch conduit. The same cable with pre-installed connectors would require a 1½inch standard conduit just to clear the connector bundle. Pulling equipment may dictate an even larger size conduit. Furthermore, the existence of previously installed cable and/or a series of 90-degree conduit bends might raise the required conduit size even higher. To compound these problems, the typical cable grip used to install cables in conduits does not expand to a size greater than a small percentage larger than the minimum allowable cable diameter, i.e., it will not fit over a connector bundle with a diameter greater than a small percentage larger than the diameter of the cable. Recently new plastic pull protectors have been developed, which allow the pull of larger bundles. However, these larger bundles cannot be pulled through most electrical ducts because of their larger diameter.

This situation has almost universally resulted in field termination (as opposed to the more desirable factory termination) of duct-installed fiber optic cables. Installing the typical epoxy and polish connector is time-consuming, and takes approximately 20 to 40 minutes per end (two ends per connection) requiring approximately 40 separate steps. For example, some of these required steps include: (1) stripping the jacket away from the cable; (2) folding back the kevlar material and stripping the buffer material; (3) cleaving or putting a break in the fiber such that the break is perpendicular to the axis of the fiber; (4) cementing the fiber inside of the connector with epoxy; and (5) polishing the fiber optic connector. The connectors may each cost as much as $10.00 or more. An incorrect installation or accidental breakage of the fragile fiber may necessitate that the connector be cut off, discarded and a new installation procedure begun, necessitating repeating all of the tedious steps, including that of polishing the connector, which is perhaps the most time-consuming. As a result, highly skilled personnel are typically required to perform field installation of de-matable connectors.

My U.S. Pat. No. 5,253,315, addressed this issue by disclosing a universal connector body provided with the capability of mating with most existing connectors on the market. A universal inner housing is provided which mates with a wide variety of coupling nut assemblies or adapters, allowing these coupling nut assemblies or adapters to mate with the universal connector body. The connector body design has the fiber terminated to a precision tip, which is spring-loaded within the housing to which the strength member is terminated to prevent interruption of the optical signal if the cable is pulled or otherwise disturbed. This design also provides for the take-up of slack buffered fiber due to the retraction of the spring-loaded tip. The manner in which the universal connector body mates with the universal inner housing provides a method of indexing the rotation of the connector body, allowing it to be tuned as to insertion loss upon installation or thereafter. The inner housing is compatible with a wide variety of connector adapters, including ST, SC, FC, D4, and high-density types.

The termination of the connector body to an optical fiber is facilitated by its unique design, which greatly simplifies the process as compared to conventional pull-proof connectors. The connector body may be terminated for pulling through a building duct by employing a unique process and a special pull boot described in this patent.

However, certain aspects of my disclosure U.S. Pat. No. 5,253,315 may be improved upon. The method of interchanging the coupling nut assemblies or adapters requires a special tool. The assembly of the universal connector body does not lend itself well to the incorporation of 900 um cable designs, and the pull protector requires a complicated housing.

Accordingly, I have invented a new and improved universal connector body, adapter and pull protector method which provides for the interchange of adapters without a tool, facilitates the incorporation of 900 um cable designs, and provides a simplified and pull protector that is relatively easier to use.

When attaching fiber optic cables to communications systems it is necessary to terminate them with fiber optic connectors. Fiber optic connectors position the fiber ends of the fiber optic cable to receive or transmit light. The surfaces of the fiber ends must be smooth and perpendicular to the fiber axis for greatest efficiency in accepting light rays. In addition, for low-loss terminations, care must be taken to preserve the domed profile of the connector ferrule or prepare the fiber such that is has a slight protrusion. Rough or dirty end surfaces block and scatter light.

The conventional method of terminating an optical fiber involves the application of epoxy and polishing with a variety of grinding papers and solutions. The objective is to polish the optical fiber end-face flat and smooth, while preserving the domed profile of the connector ferrule. This glue and polish practice is wide-spread, although it has been found to provide acceptable results, such results vary depending upon the skill of the operator.

The typical steps of the conventional means to terminate fiber optic connectors onto a fiber optic cable include approximately 43 steps as follows:

Gather all materials (fiber cable, connectors, epoxy, syringes, polishing film, fiber disposal bin, and toolbox);

Place everything on the table in a convenient location;

Open connector package and lay-out all parts. Do not take dust cap off the connector ferrule yet;

Prepare the cable;

Push rubber strain relief boot about 4 inches up the cable;

Push the crimp ring up the cable to the boot (make sure it is on in the right direction);

Strip a length of jacket from the fiber, depending upon the specific connector type;

Cut the kevlar to some length depending upon the specific connector type;

Strip the buffer ¼″ at a time until some length of fiber is exposed, depending upon the specific connector type;

Clean the fiber;

Prepare epoxy;

Place needle on syringe to receive the epoxy;

Mix epoxy;

Pour into syringe;

Replace plunger;

Hold upright and slowly get air out of syringe;

Select connector;

Remove dust cap from connector;

Push syringe all the way into connector;

Push in plunger to inject epoxy until a bead appears on the end of the ferrule of the connector;

Pull the syringe halfway out of the connector and fill the backshell with epoxy carefully;

Insert the fiber into the connector and carefully work it through the ferrule, twisting the connector as you go, until the fiber is in as far as possible;

Insure that you have a good-sized bead of epoxy on the tip of the ferrule;

Push the crimp sleeve up, capture the kevlar and crimp it to the back-shell of the connector;

Crimp the back of the crimp sleeve to the cable;

Push the boot over the crimp sleeve;

Wipe off excess epoxy from the protruding fiber. Be careful not break off the fiber or remove the epoxy bead at the tip of the ferrule. Fiber breakage at this point could make connector unusable;

Cure the epoxy. Cure only until the bead of epoxy is hardened. The epoxy inside the ferrule will cure fully at room temperature in less than 24 hrs;

Cleave and polish using the following steps: Gather up tools and supplies, set up polishing plate with 3 and 0.3 micron lapping film (the connector is ready for cleaving and polishing when the epoxy bead on the tip is hardened), cleave the fiber, using 15micron film, “Air Polish” to remove most of the protruding fiber and epoxy bead, and air polish with 12 micron film to remove burr and most of the epoxy bead;

Put connector in polishing puck;

Lay gently on 3 micron film;

Polish with a FIG. 8 motion until epoxy bead is gone and it gets “slippery”;

Wipe off;

Polish a few figure “8's” on 3 micron film;

Clean;

Test;

View in microscope; and

Test for loss.

These steps must be carefully followed and checked by experienced persons in order to achieve acceptable results. An alternative to this 43-step termination method is to use less durable termination processes with lower environmental performance. Alternatively, much more expensive connectors can be used which may eliminate some of these termination steps.

There exists a need to improve this method cheaply and efficiently, in that regard, I have invented an apparatus and method for the termination of optical fiber connectors with little or no polishing. This device and method produces consistent, low-loss terminations with considerably less effort that the 43-step method and using conventional inexpensive connectors. Also, this device and method preserves the domed profile of the connector ferrule and enables preparation of the fiber such that is has a slight protrusion if desired. Furthermore, this device and method has been found to yield the best fiber contact between mating connectors and, therefore, the lowest loss and back reflection.

### SUMMARY OF THE INVENTION

A new and improved apparatus and method for installing fiber optic cables, resolving the deficiencies of past systems, is disclosed herein. The inventive system serves to simplify the process of installing fiber optic cables and reduce the associated installation and equipment costs.

The inventive components comprise a new and improved universal connector body capable of securing a fiber optic cable and being mated with a new and improved coupling nut assembly or new and improved adapter. The universal connector body has an inventive retaining device to capture and secure receiving devices on the coupling nut assembly or adapter. The inventive components are also suitable for mating with existing connectors on the market.

The present invention also provides for capturing and securing a spring-loaded cap or ferrule assembly within the inventive universal connector body housing, which may then be captured and secured in an inventive coupling nut assembly, thus preventing separation of the terminated ends of fiber within the components.

The present invention further provides a new and improved pull-protector apparatus for protecting one or more pre-terminated universal connector bodies while being pulled through a duct or conduit during installation of a communications system.

The present invention further provides a new and improved apparatus and method for aligning the fiber optic connector end-face while terminating the fibers. An inventive positioning apparatus and method provides a view of the precise location of the fiber optic fiber with respect to the fiber optic connector end-face, thus enabling a technician to properly align the fiber optic fibers in the fiber optic connector while cementing material is setting. The resulting termination is characterized by optimal positioning of the fiber and a very low insertion loss and back reflection, thus minimizing or even eliminating the time-consuming step of polishing connector end-faces for both multimode and single-mode terminations.

An inventive adapter for adapting different connector and fiber optic cable formats. In particular, the inventive adapter is useful for connecting the 2.5 mm diameter type, characteristic of the ST, FC and SC connector interfaces or other connector types, to duplex connector formats with closely-spaced fibers, like the 0.75 millimeter fiber separation of the MT-RJ connector or other industry standard fiber optic simplex and duplex connectors. The inventive adapter allows for immediate interfacing of other connector formats to duplex fiber optic connectors with closely-spaced fibers without employing expensive jumper cables.

### BRIEF DESCRIPTION OF THE DRAWINGS

FIG. 1 is a diagram useful to explain the assembly process showing the ferrule assembly being captured by the new and improved universal connector body housing, which in turn, is sliding into a new and improved coupling nut assembly or adapter;

FIG. 2 is a cross-section of a fiber optic cable with a fiber stripped and prepared for termination to the ferrule assembly of the present invention;

FIG. 3 is a cross-section of the ferrule and universal connector body housing with a fiber optic cable in place, prior to the ferrule and universal connector body housing being engaged;

FIG. 4 is a top view of the ferrule and universal connector body housing with a fiber optic cable in place, after the ferrule and universal connector body housing have been engaged;

FIG. 5 is a cross-section of the inventive pull-protector, showing the attachment of two terminated ferrule and universal connector body housing assemblies with the pull-protector;

FIG. 6 is a cross-section of the inventive pull-protector of FIG. 5, illustrating the configuration of the two terminated ferrule and universal connector body housing assemblies while attached to and being pulled by the inventive pull-protector;

FIG. 7 is a cross-section of a terminated ferrule and universal connector body housing assembly and inventive coupling nut assembly, prior to the engagement of the ferrule and connector assembly;

FIG. 8 is a cross-section of the terminated ferrule and universal connector body housing assembly and inventive coupling nut assembly of FIG. 7, after engagement of the ferrule and universal connector body housing assembly;

FIG. 9 is a diagram useful to explain the assembly process of a second embodiment of the present invention, in which a ferrule assembly is captured by an alternative method and alternative embodiment of the inventive universal connector body housing;

FIG. 10 is a cross-section of the ferrule and fiber optic cable of the present invention being terminated onto a stripped fiber optic cable in accordance with the alternative method;

FIG. 11 is a cross-section of the ferrule and universal connector body housing assembly with a fiber optic cable in place, after the assembly has been engaged, in accordance with the second embodiment illustrated in FIG. 9;

FIG. 12 illustrates the attachment of the two terminated ferrule and universal connector body housing assemblies of FIG. 9 with the inventive pull-protector;

FIG. 13 illustrates the configuration of the two terminated ferrule and universal connector body housing assemblies of FIG. 9 while attached to and being pulled by the pull-protector;

FIG. 14 is a cross-section of the terminated ferrule and universal connector body housing assembly in accordance with the second embodiment, and inventive coupling nut assembly, prior to the engagement of the ferrule and universal connector body housing assembly;

FIG. 15 is a cross-section of the terminated ferrule and universal connector body housing assembly in accordance with the second embodiment, and inventive coupling nut assembly, after the engagement of the ferrule and universal connector body housing assembly;

FIG. 16 is an illustration useful for explaining the inventive termination method of optical fiber connectors with little or no polishing;

FIG. 17 is an illustration useful for explaining the viewing procedure for determining the fiber end-face position relative to the connector ferrule end-face and fiber protrusion δ; and

FIG. 18 illustrates the inventive adapter and method for use with the disclosed inventive components or other standard fiber optic formats.

### DESCRIPTION OF THE PREFERRED EMBODIMENTS

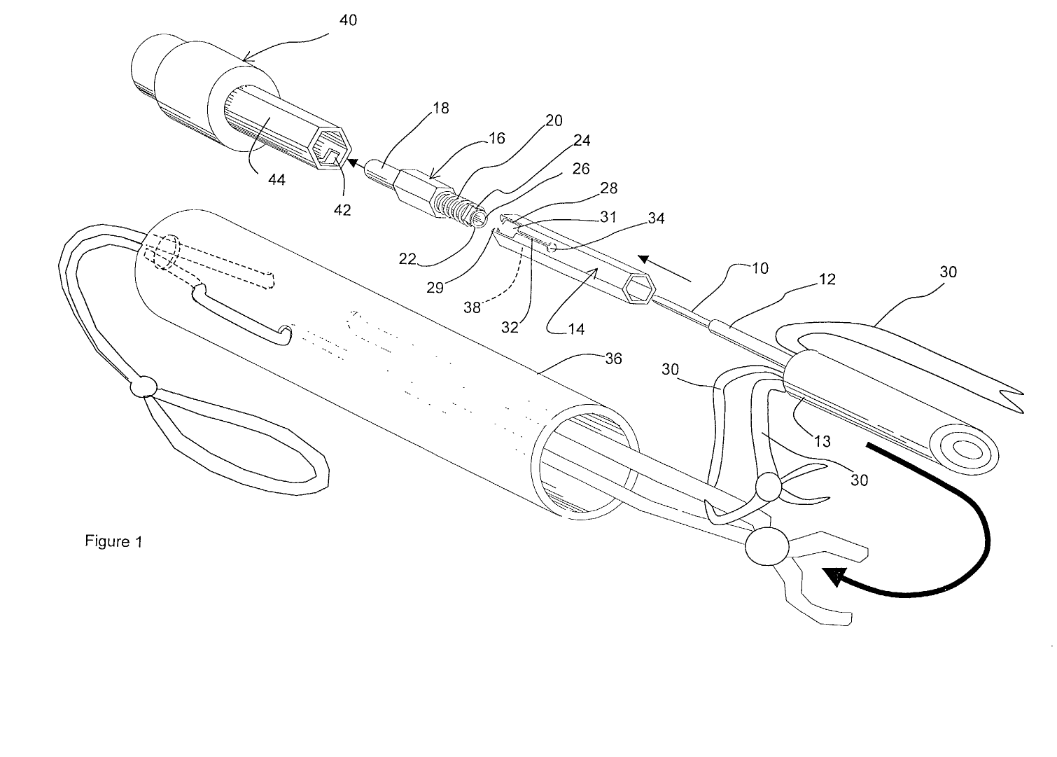

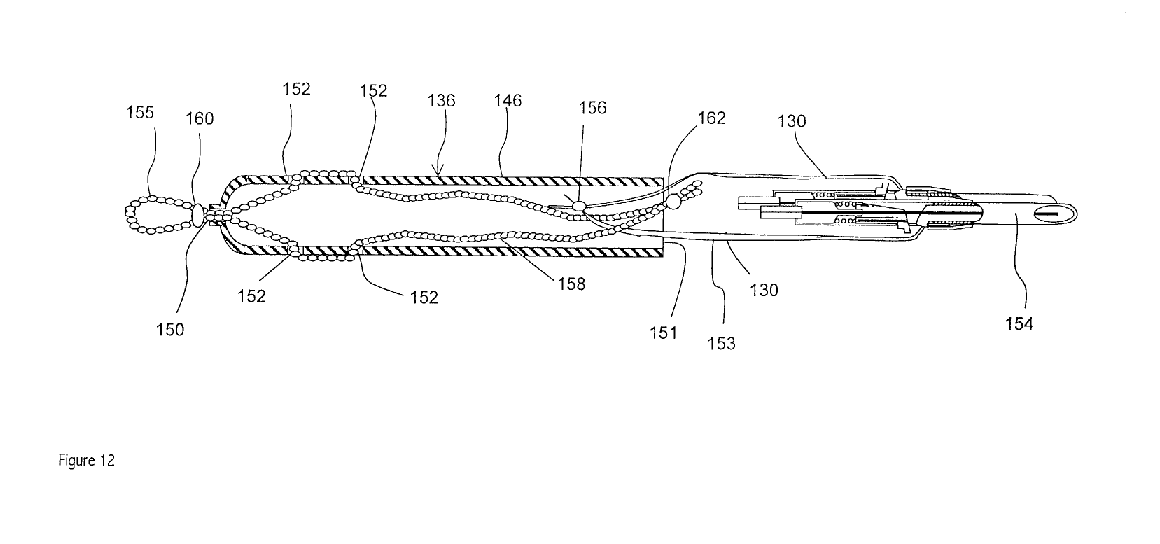

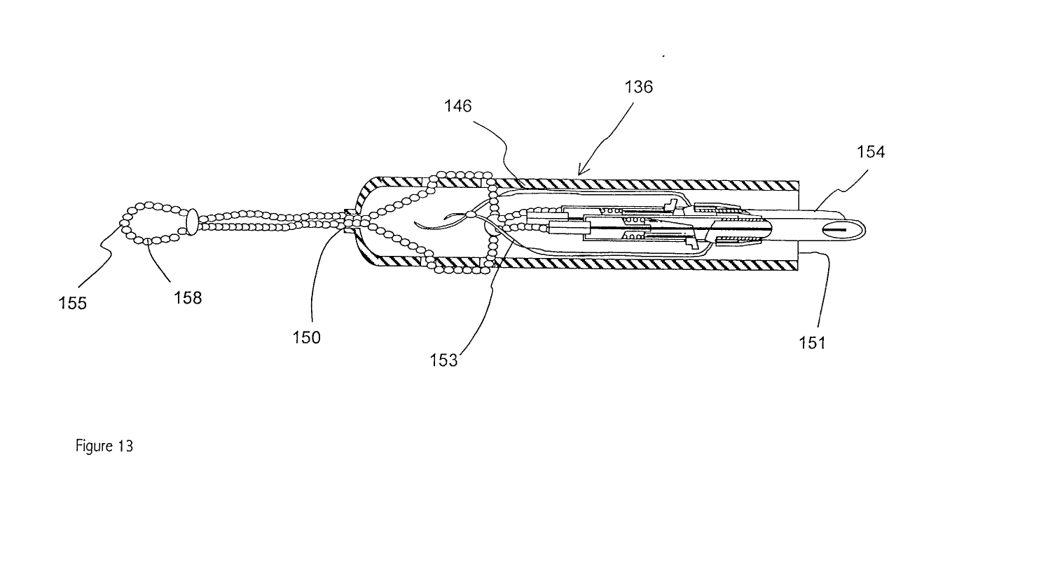

Reference is made to FIGS. 1-18 of the drawings in detail, which show the assembly and installation procedure for the new and improved universal connector body.

Referring to FIG. 1, fiber 10 from fiber optic cable 12 is inserted through universal connector body housing 14, and engaged by a ferrule 16 having a hollow ceramic tip 18. A spring 20 is disposed over a length of hollow tube 22 having a protruding member 24 proximate to opening 26 in the hollow tube 22. Protruding member 24 secures spring 20 on tube 22, and functions to connect the body housing 14, as will be discussed below.

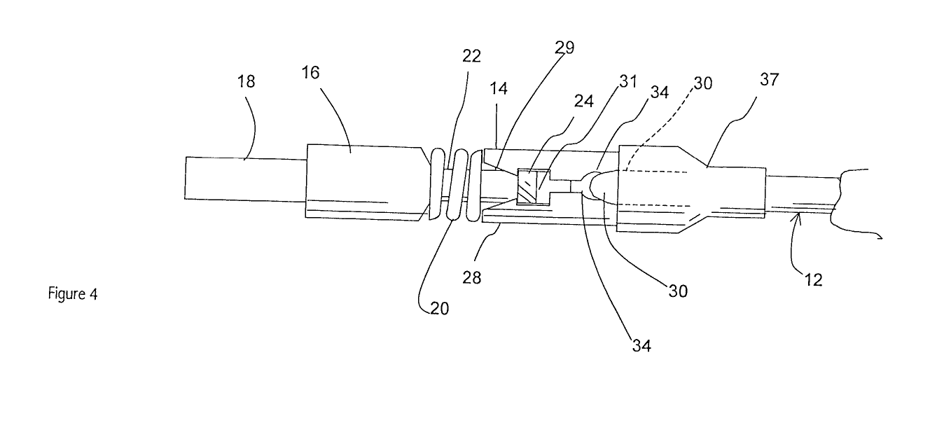

Ferrule 16 is connected with connector body housing 14 by a retaining device. In this embodiment, the retaining device comprises inserting protruding member 24 into gripping device 28 on a universal connector body housing 14, as illustrated in FIG. 4. Gripping device 28 has ramps 29 which are slanted to allow member 24 to be easily inserted into and locked into position but not easily removed from opening 31. Opening 3lis configured to engage member 24 upon its insertion.

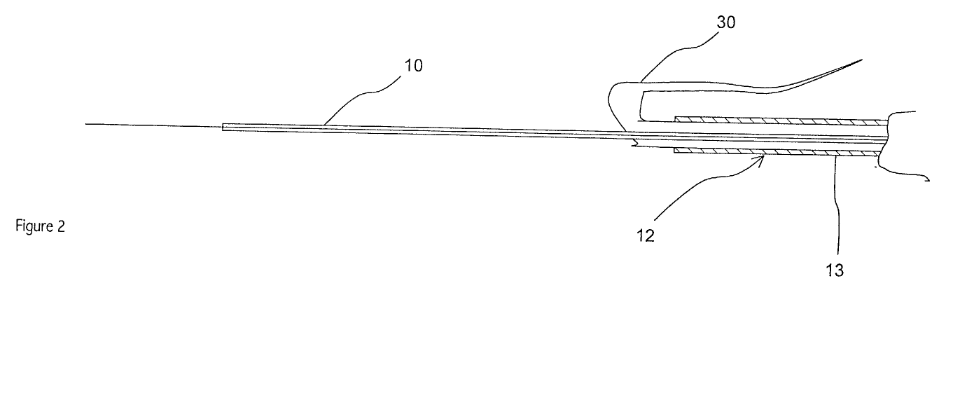

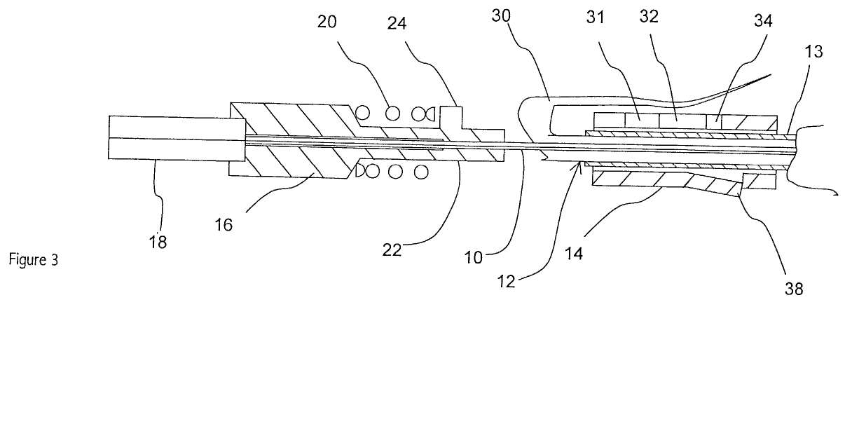

FIG. 3 illustrates fiber 10 inserted through ferrule 16 and connector body housing 14 just prior to member 24 being engaged by gripping device 28 and kevlar ends 30 being set through opening 34. The universal connector body housing 14 is installed over the fiber optic cable 12 before the termination process. Ripped open and pulled away kevlar sheath ends 30 surround fiber 10 and are pulled away from cable 12 after fiber 10 and kevlar 30 is inserted through ferrule assembly 16. Cable 12 also has an exterior casing 13, which is typically made of PVC or plastic material. FIG. 2 illustrates fiber optic cable 12 being stripped of casing 13 to expose kevlar 30 and fiber 10. When cable 12 is passed through connector body housing 14 and retaining device 29 is engaged, ferrule 16 is secured to housing 14. Separated kevlar ends 30 are slipped through opening 31 into slot 32 and finally into opening 34. Opening 34, slot 32 and opening 31 are cut in universal connector body housing 14. Kevlar ends 30 are exposed to a sufficient length to enable their attachment to a pull protector 36.

As shown in FIG. 4, the kevlar ends 30 and universal connector body housing 14 may be fixed to cable 12 by using an adapter tube 37, which is placed over cable 12 before cable 12 is connected to ferrule 16. Adapter 37 has an end configured to engage housing 14 and an opposing end configured to engage cable 12. Preferably, adapter tube 37 is filled with adhesive prior to it being installed on housing 14 and cable 12. A latch 38 (FIG. 3) on universal connector body housing 14 secures housing 14 on coupling nut assembly 40 as shown, or an adapter, by engaging slot 42 (FIG. 1) in receiving tube 44 on coupling nut 40, as shown in FIG. 1. Housing 14 would be installed in coupling nut 40 once the fiber 10, ferrule 16 and housing 14 are assembled together.

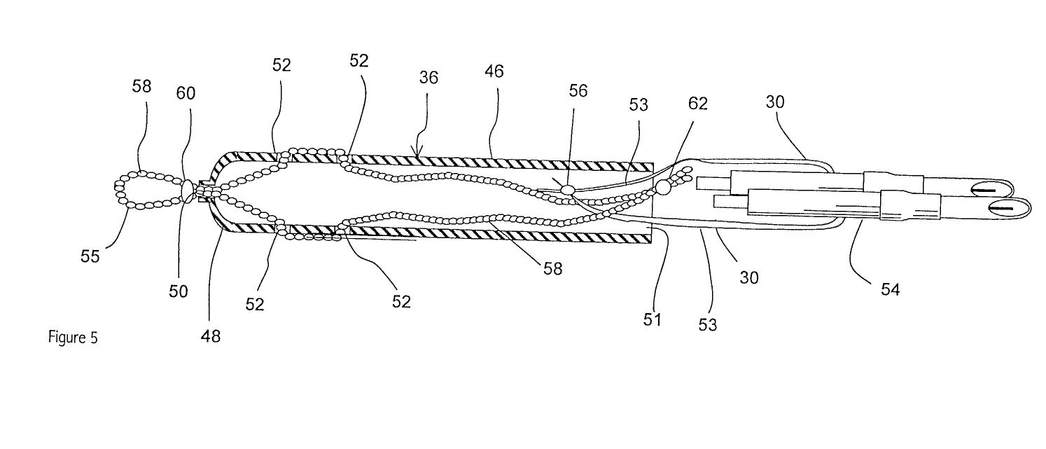

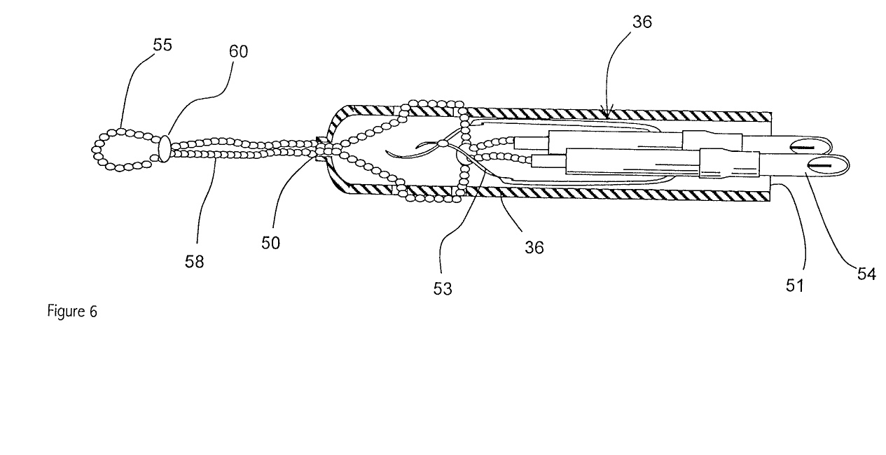

Kevlar ends 30 may also be attached to pull-protector 36 in the manner shown in FIG. 5. Pull-protector 36 consists of a central cylinder 46 sufficiently large enough to contain at least one pre-terminated universal connector housing 14. Preferably, cylinder 46 is sufficiently large enough to contain several pre-terminated universal connector housing bodies. Central cylinder 46 has a closed end 48 with an opening 50, an open end 51 for receiving the pre-terminated universal connector housings 14 and a pair of opposing cylinder side openings 52. Kevlar ends 30 of two universal fiber optic cable assemblies 54 are fixed together at 56 by any conventional means, thus forming a first loop 53. Rope 58 is threaded from the inside of cylinder 46 through opening 50 and fixed by a knot 60 or epoxy drop to form a loop 55 on the outside of closed end 48 and prevent it from slipping back through opening 50. The ends of rope 58 are threaded through side openings 52 and then fixed around the first loop 53 by knot 62, an epoxy drop, or similar artifice. Thus, pulling on rope 58 while holding cylinder 46 in place results in pulling the first loop and the universal cable assemblies 54 into the cylinder but not beyond the point at which side openings 52 are located, as illustrated in FIG. 6. This procedure protects the universal fiber optic cable assemblies 54 while installation is being completed by the cable being pulled through a pipe or other conduit with the pull-protector protecting the forward end of the cable while it is being pulled forward, after which the pull-protector is removed.

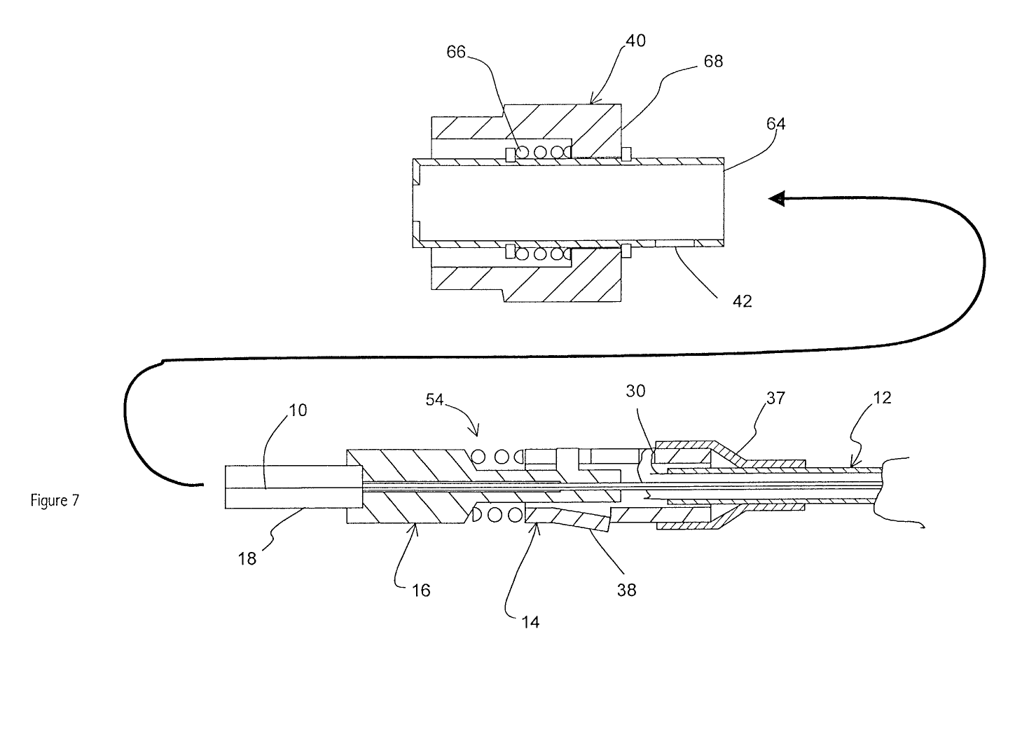

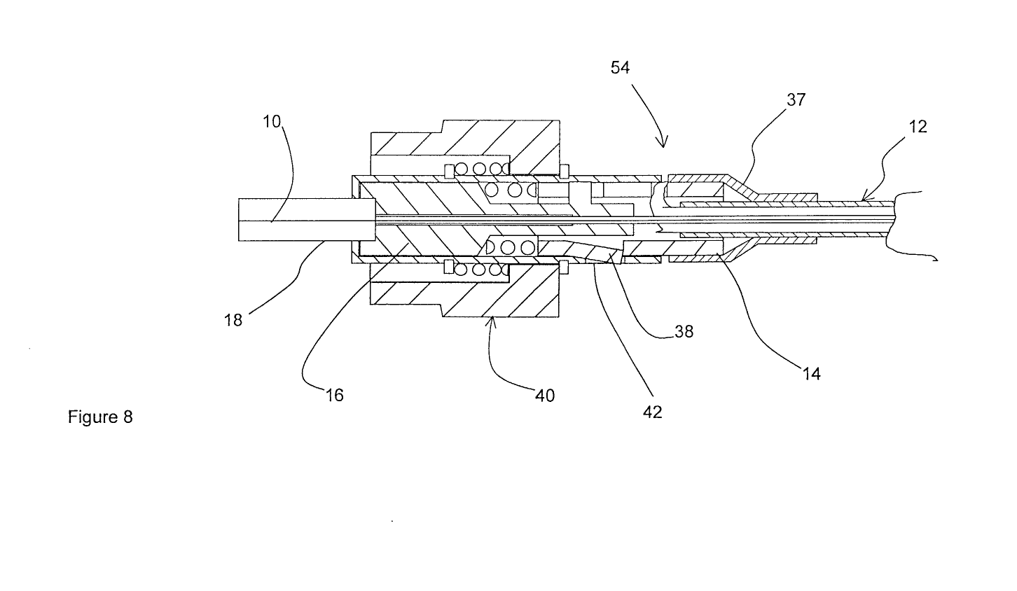

Once the universal fiber optic cable assembly 54 is terminated, for example, after having been installed in a communication duct or tray, kevlar ends 30 that were attached to the pulling rope 58 of the pull-protector 36 are cut and the assembly 54 is inserted into coupling nut assembly 40, as illustrated in FIGS. 7 and 8. Upon insertion, latch 38 engages slot 42 to keep assembly 54 within coupling nut 40. Assembly 54 may then be removed by depressing latch 38 while pulling assembly 54 from coupling nut 40. Coupling nut 40 comprises hollowed out tube 64 and spring 66 within housing 68. Tube 64 has an opening at one end configured to engage assembly 54 and an opening at the other end configured to engage ceramic tip 18.

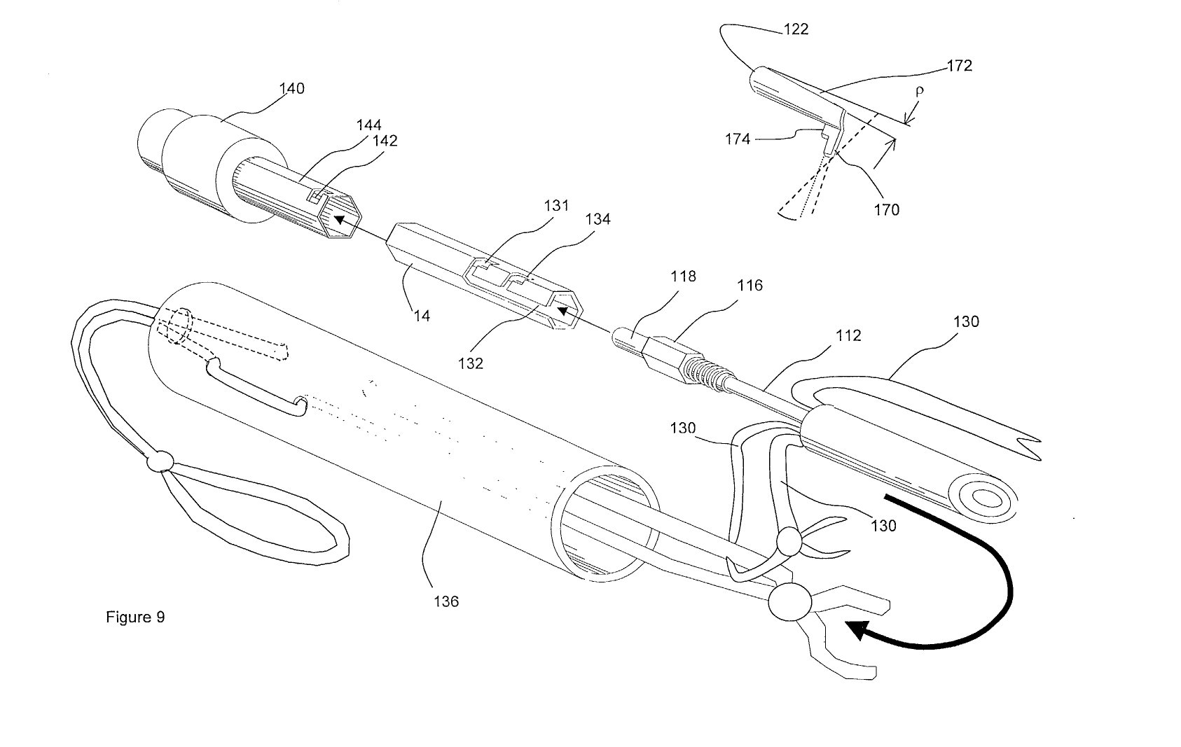

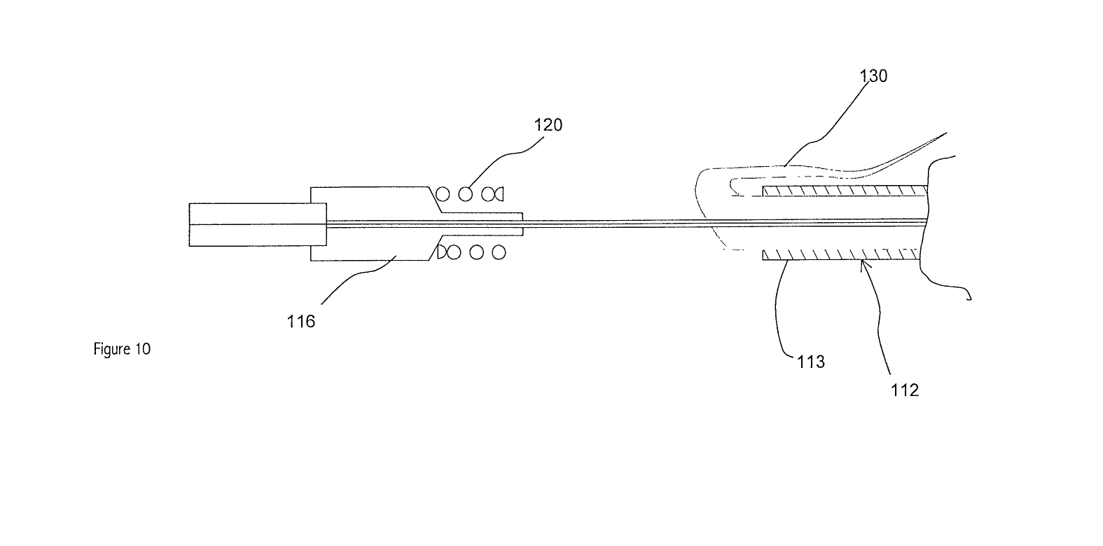

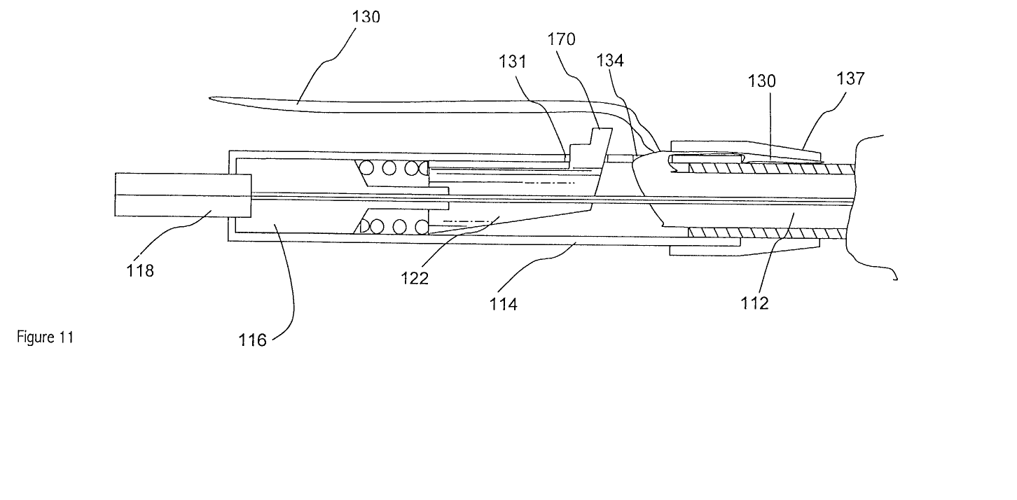

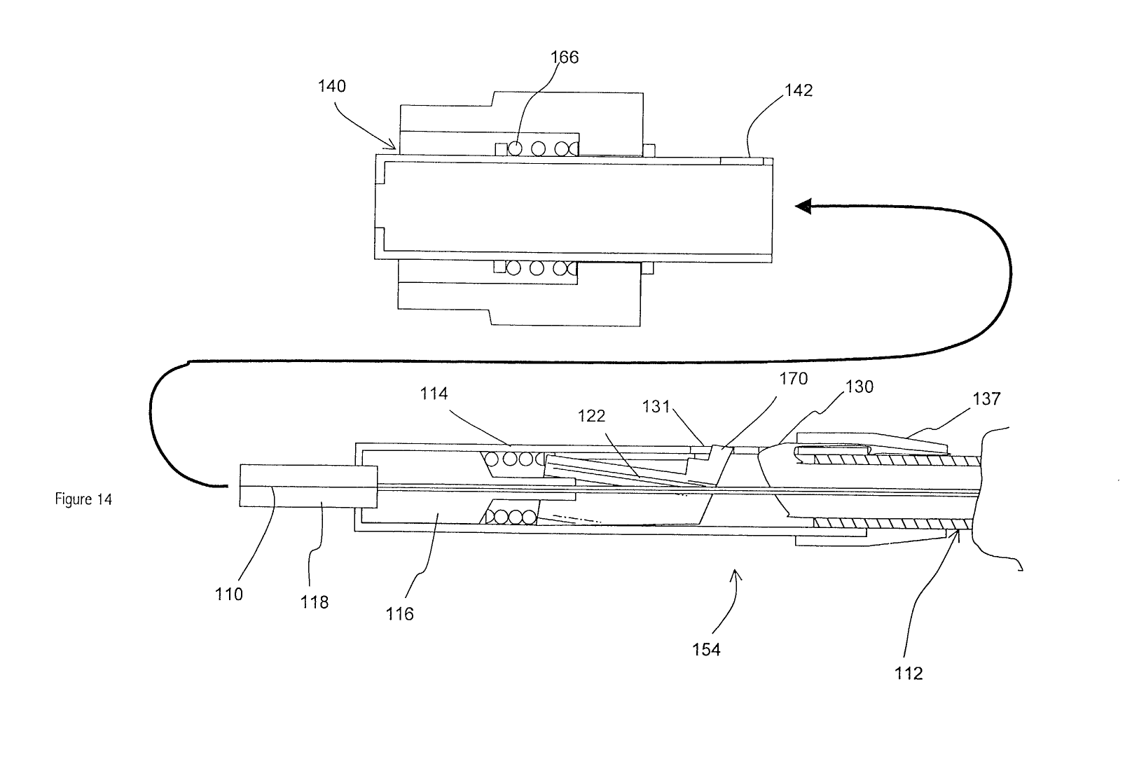

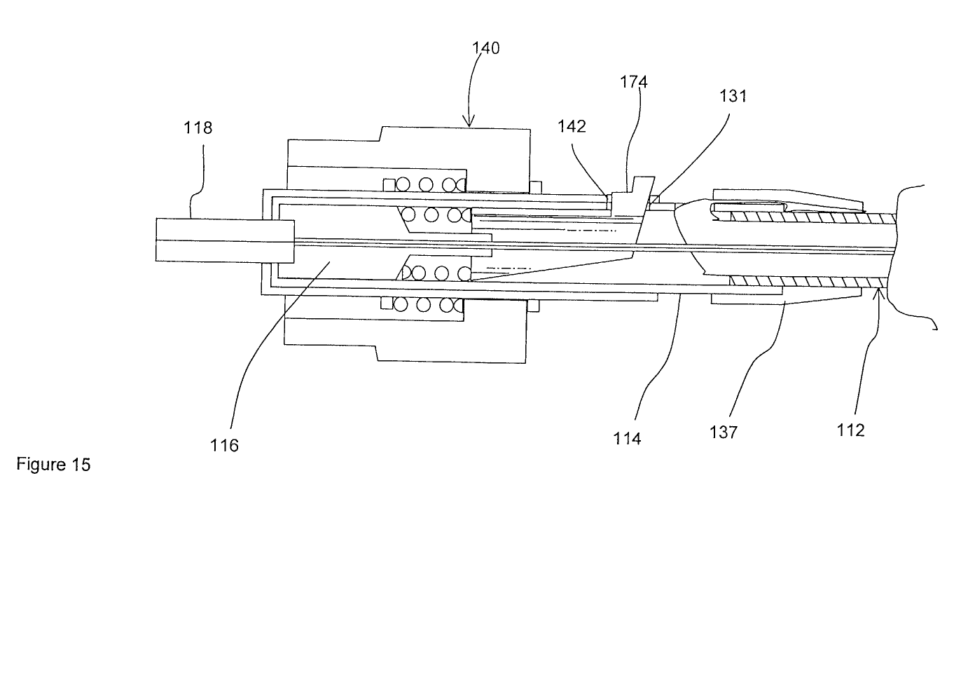

FIGS. 9-15 illustrate an alternative embodiment of the universal connector body 114 and retaining device. In this second embodiment, universal connector body housing 114 has a longitudinal groove 132 connected to two slots 131 and 134 cut out in housing 114. Slot 134 receives kevlar ends 130 from fiber optic cable 112. As shown in FIG. 11, one or more of the kevlar ends 130 is reserved for attaching to pull-protector 136. The second segment 44 is brought out of the new and improved universal connector body housing through slot 38 and captured on the rear of the Ferrule 116 is connected to cable 112 before being inserted into housing 114, as illustrated in FIG. 10. Retaining member 122 is a separate part which is inserted into universal connector body housing 114 to retain ferrule 116, by sliding tab 170 through groove 132 into engagement with slot 131. Member 122 has a beveled bottom 172, which permits it to be depressed inside of universal connector body housing 114 by pushing down on tab 170, thus enabling tab 170 to be inserted into tube 144 of coupling nut 140 as shown, or an adapter, and engaged with opening 142. After engagement, the lower step 174 of tab 170 is used to fill slot 131 and opening 142 to further secure the assembly and prevent relative motion between parts, as illustrated in FIG. 15. The beveled bottom 172 maintains tab 170 in a substantially upright position within slot 131 and opening 142, when not being forcibly depressed, as illustrated by arrow 176 in FIG. 14.

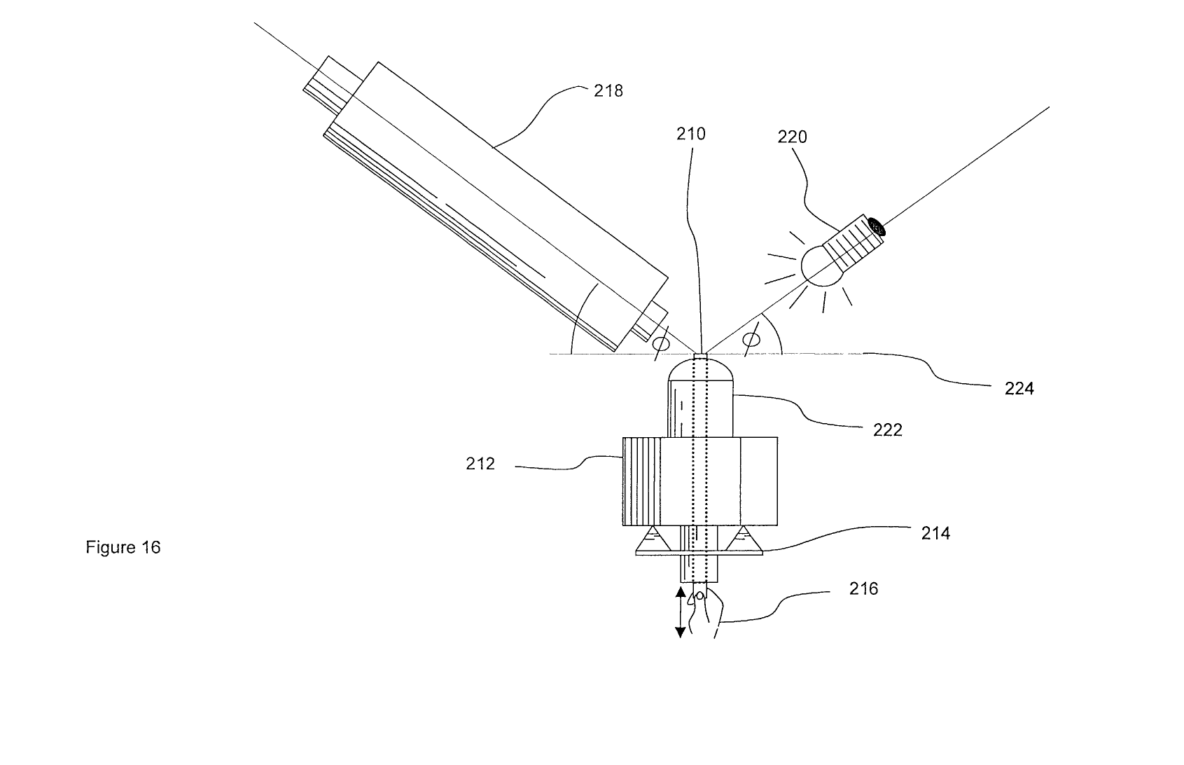

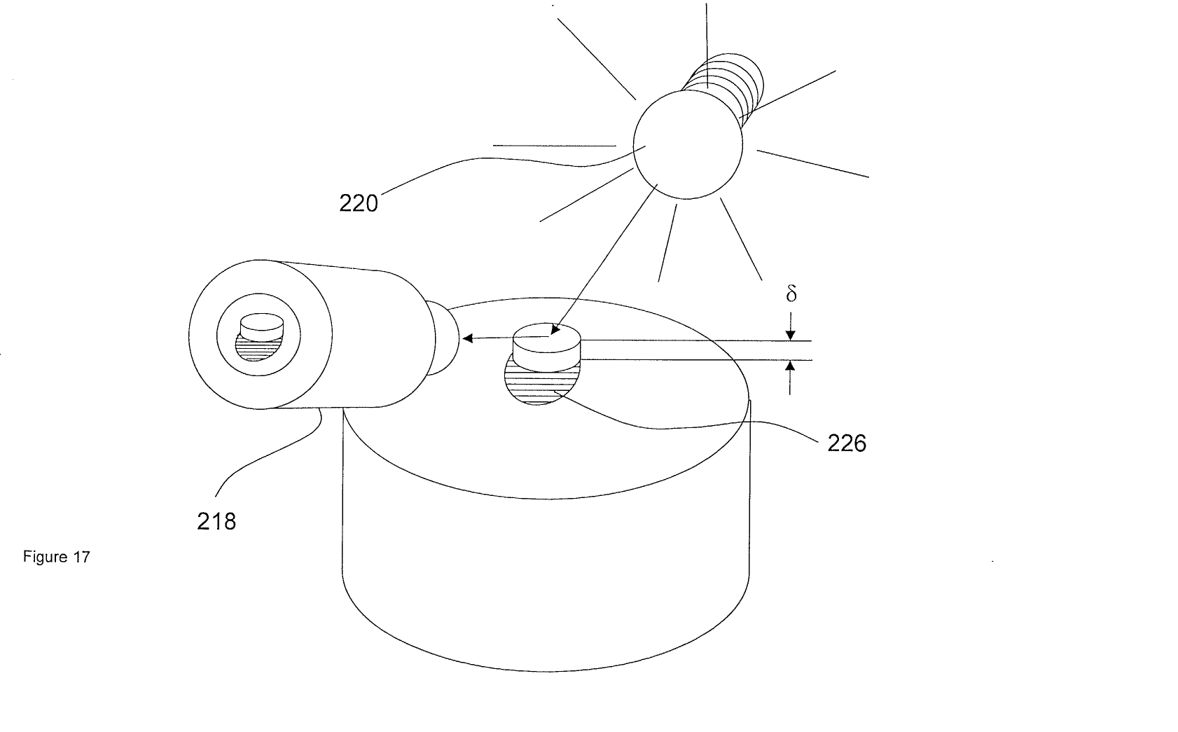

FIGS. 16-17 illustrate the method and apparatus for termination of a fiber optic cable with little or no polishing in detail. An optical fiber 210 is cleaved perpendicular to its axis to within one degree. Fiber 210 is inserted into an optical fiber connector 212 filled with a curing adhesive. The optical fiber connector 212, with fiber 210 inserted, is positioned in a termination mechanism consisting of a holder 216 (which may be the user's hand) for fiber optic connector 212, a fiber positioning device 214, a microscope 218 for viewing fiber 210, and a lamp 220 for illuminating the end of ferrule 222 and fiber 210.

Holder 216 for fiber optic connector 212 keeps connector 212 secured so that stable viewing of the protrusion of the fiber 210 in the ferrule 222 is possible. The microscope 218 for viewing fiber 210 and lamp 220 for illuminating the end-face of fiber 210 and ferrule 222 are positioned on opposite sides of fiber 210 and ferrule 222, but at the same angle φ with respect to plane 224 of the fiber end-face. This geometric arrangement of microscope 218 and lamp 220 permits the lamp light to reflect into microscope 218, thus providing brilliant illumination of the position of fiber 210 with respect to the ferrule end-face. Then, using fiber-positioning device 214, fiber 210 may be adjusted to a perfect, slightly protruded, position before the adhesive is cured. Also, the fiber end-face protrusion relative to the connector ferrule δ may be determined by comparing shadow 226 cast by lamp 220 to a graticule etched on the optics of microscope 218, as illustrated in FIG. 17.

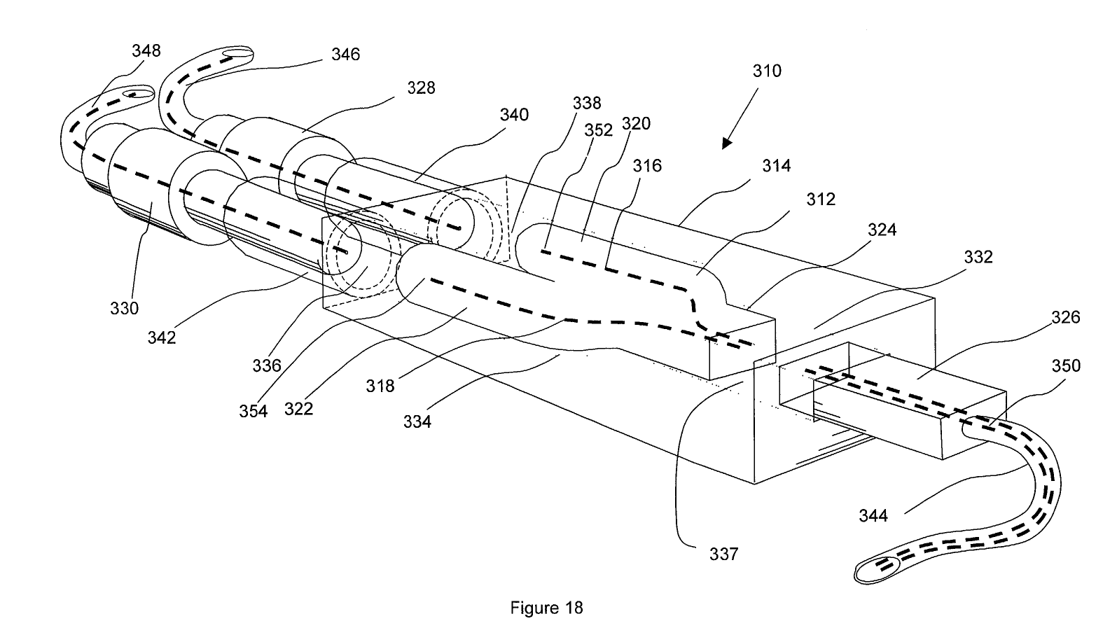

Reference is now made to FIG. 18, which illustrates an adapter 310, which may be used with the inventive universal housing 14 or 114, for mating fiber optic cables and components. Adapter 310 comprises a fiber carrier or conduit 312 inside a housing 314. Fiber optics channels 316 and 318 which permit light to travel through adapter 310 are contained within conduit 312. Conduit 312 spans housing 314, having two ends 332 and 334. Fiber optics channels 316 and 318 terminate in duplex connector interface 324 near end 332, and extend separately and terminate in two ferrule legs 320 and 322 near end 334, thus creating spaces 336, 337 and 338 in conduit 312 within housing 314. Spaces 336, 337 and 338 have coupling and retaining devices for securely mating components within housing 314. The coupling and retaining devices may be any conventional device, such as a snap-fitting engagement or retaining devices previously discussed and illustrated in FIGS. 1 and 9, that is, such as the latch 38 or tab 170 and corresponding slots 42 and 142, respectively. Spaces 336, 337 and 338 also allow conduit 312 to slide longitudinally within housing 314 to protect ferrule legs 320 and 322 and duplex fiber optic connector interface 324 from the force applied when mating adapter 310 with other components.

A duplex connector 326, connected to a duplex or multi-channel fiber optic cable 344 having fibers 350, is inserted into housing 314 to connect with interface 324. Thus, when connector 326 is mated with interface 324, light from fiber optic channels 316 and 318 is able to travel through connector 326 and into fibers 350 of cable 344.

Generic coupling sleeves 340 and 342 of two single-channel fiber optic connectors 328 and 330, respectively, are inserted into conduit 312 at end 334 to connect with legs 320 and 322, thus permitting light to travel through fiber channels 316 and 318 into cables 346 and 348. Ferrules 320 and 322 are sufficiently spaced to allow proper mating with individual single channel fiber optic connectors 328 and 330.

Fibers 316 and 318 are polished or otherwise suitably prepared so as to enable a low-loss connection at points 352 and 354 and at interface 324. The polishing process enables the light traveling in the fibers of one connector to pass, with low attenuation, to the fibers of the mating connector. Typically, manufacturers of duplex connectors employ close spacing of fibers to enable the duplex connector to maintain a compact width and height.

Adapter 310 may also be configured for alternative formats of fiber cables, such as the 0.75 millimeter fiber separation characteristic of the MT-RJ connector interface. Ferrules 320 and 322 may be of the simplex 2.5 mm diameter type, which is characteristic of the ST, FC and SC connector interfaces and other connector types. Furthermore, adapter 310 may also be connected to the universal fiber optic connector of U.S. Pat. Nos. 4,711,517 and 5,253,315 and to the MT-RJ connector without employing expensive jumper cables.

While illustrative embodiments of the invention have been described above, it is, of course, understood that various modifications will be apparent to those of ordinary skill in the art. Many such modifications are contemplated as being within the spirit and scope of the invention.

1. A fiber optic cable connector device for securely coupling a fiber optic cable end portion for use in installing a fiber optic cable network, comprising:
(a) a cap member having an axial bore, said cap member having a first end for receiving and securing a fiber optic cable end portion therein and a second end for exposing the fiber end of the fiber optic cable end portion;
(b) a sleeve member having an axial bore being of sufficient diameter to permit a fiber optic cable end portion to be inserted therethrough, said sleeve member having a first end for receiving a fiber optic cable and a second end for receiving said first end of said cap member; and,
(c) a retaining device for securely coupling said cap member with said sleeve member, said retaining device having a first engaging portion proximate to the first end of said cap member and a second engaging portion proximate to the second end of said sleeve member, said retaining device being engaged by inserting the first end of said cap member into the second end of said sleeve member.

2. A device as in claim 1, further comprising a coupling member having an axial bore for receiving and securing a coupled sleeve member and cap member, said coupling member having a first end with a retaining device wherein said retaining device is engaged by inserting said coupled sleeve member and cap member in said coupling member, and a second end for receiving said second end of said ferrule member and exposing the fiber end portion.

3. A device as in claim 1, wherein said retaining device comprises a two ramped surfaces on said second end of said sleeve member engageable with a protruding member on said first end of said cap member.

4. An adapter for coupling two single-fiber carrying fiber optic cable end portions with a dual-fiber carrying fiber optic cable, comprising:
(a) a support member having a housing with openings therein for receiving two single-fiber carrying fiber optic cables and a dual-fiber carrying fiber optic cable; and
(b) a dual fiber carrying member being slidably mounted within said housing, said dual fiber carrying member having a first end with a dual-fiber interface, a forked middle portion, and two branches having second and third ends, said second and third ends each being engageable with one single-fiber carrying fiber optic cable, respectively.

5. A method for terminating a fiber optic cable with little or no polishing, comprising:
Cleaving an exposed fiber within one degree perpendicular to its axis;
Inserting said fiber into a connector filled with a curing adhesive;
Viewing said fiber through a microscope while directing illumination on the end-face of said fiber; and,
Adjusting the position of said fiber to an optimal position within said connector before said adhesive is cured based on the view through the microscope.
